(19) United States
(12) Patent Application Publication
(10) Pub. No.: US 2024/0430713 A1
(43) Pub. Date: Dec. 26, 2024

(54) RADIO NODE AND METHOD IN A WIRELESS COMMUNICATIONS NETWORK

(71) Applicant: Telefonaktiebolaget LM Ericsson (publ), Stockholm (SE)

(72) Inventors: Tore LINDGREN, Luleå (SE); Torsten DUDDA, Wassenberg (DE); Alberto HATA, Campinas SP (BR); Emrah TOMUR, Izmir (TR)

(21) Appl. No.: 18/290,867

(22) PCT Filed: Jul. 27, 2021
(86) PCT No.: PCT/SE2021/050751

§ 371 Date: Jan. 22, 2024

(51) Int. Cl. H04W 24/04; G01S 5/02; H04W 16/26; H04W 56/00; H04W 64/00

(52) U.S. Cl. CPC H04W 24/04; G01S 5/0215; H04W 16/26; H04W 56/001; H04W 64/003

(57) ABSTRACT

A method performed by a radio node for determining the presence of a repeater repeating a signal related to positioning or synchronization in a wireless communications network is provided. The radio node obtains a respective first characteristic for one or more received signals. The first characteristic is related to parameters associated to multipath indications. The radio node determines the presence of the repeater by detecting an anomaly based on the respective first characteristic.

### TECHNICAL FIELD

Embodiments herein relate to a radio node and a method therein. Furthermore, a computer program and a computer readable storage medium are also provided herein. In particular, embodiments herein relate to determining the presence of a repeater repeating a signal related to positioning in a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Meaconing attacks, where a delayed and amplified copy of a received signal is transmitted, is a serious threat to the use of radio navigation and synchronization systems. Radio navigation systems as well as systems based on clock synchronization may be based on e.g. Global Navigation Satellite System (GNSS) or 3GPP standards. Due to the nature of the attack, it is notoriously hard to detect since the communication continues to operate as expected. It is thus not possible to mitigate the threat using standard means such as encryption of the signal.

### SUMMARY

As a part of developing embodiments herein a problem was identified by the inventors and will first be discussed.

The existing methods to detect meaconing attacks are typically based on one, or a combination, of the two techniques listed below:
Absolute power measurements. Since the signal is amplified and retransmitted by the meaconing equipment, the signal power seen by the receiver will increase. The absolute power of the received signal can therefore be used to detect meaconing attacks. This is typically not a very reliable method due to the large natural variations in the noise levels.
Collaborative navigation. Since all signals in the frequency band in which the meaconing equipment operates are retransmitted from the same location, the result is that the signals used for the positioning of different devices will indicate that these are in the same location. This can be used for detection of a meaconing attack either by comparing the reported position of the devices or by comparing the pseudo-ranges used to calculate the position of different devices. This is considered inefficient, since a device that suffer from the meaconing attack is not able to detect it. The device must rely on other network equipment for the detection.

Thus, there exists a need for simple efficient method to detect meaconing attacks in order to improve the reliability of the wireless communications network.

An object of embodiments herein is to improve the reliability of a wireless communications network.

According to an aspect of embodiments herein, the object is achieved by a method performed by a radio node for determining the presence of a repeater repeating a signal related to positioning or synchronization in a wireless communications network. The radio node obtains a respective first characteristic for one or more received signals. The first characteristic is any one out of: An autocorrelation of a received signal, and a value representative of a radio channel related to a received signal. The radio node determines the presence of the repeater by detecting an anomaly based on the respective first characteristic.

According to another aspect of embodiments herein, the object is achieved by a radio node configured to determine the presence of a repeater repeating a signal related to positioning or synchronization in a wireless communications network. The radio node is further configured to:
obtain a respective first characteristic for one or more received signals, which first characteristic is adapted to be any one or more out of:
an autocorrelation of a received signal, and
a value representative of a radio channel related to a received signal, and
determine the presence of the repeater by detecting an anomaly based on the respective first characteristic.

Since the radio node obtains a respective first characteristic for one or more received signals, it is possible for the radio node determine the presence of the repeater repeating the signals related positioning or synchronization by detecting the anomaly based on the respective first characteristic, e.g. by comparing the respective first characteristics. This results in a more reliable wireless communications network.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting embodiments of a method in a radio node.

FIGS. 3a-b are diagrams illustrating embodiments herein,

FIGS. 4a-b are schematic block diagrams illustrating embodiments of a network node.

FIG. 5 schematically illustrates a telecommunication network connected via an intermediate network to a host computer.

FIG. 6 is a generalized block diagram of a host computer communicating via a base station with a user equipment over a partially wireless connection.

FIGS. 7-10 are flowcharts illustrating methods implemented in a communication system including a host computer, a base station and a user equipment.

### DETAILED DESCRIPTION

An object of embodiments herein is to improve the reliability of a wireless communications network.

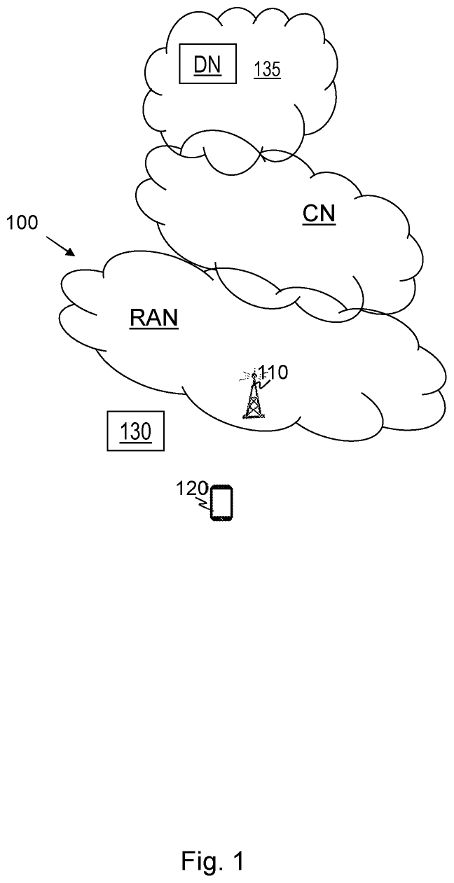

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Network nodes such as e.g. a radio node 110, and in some embodiments a radio node 120, operate in the wireless communications network 100. In some embodiments herein the radio node 110 is referred to as a network node 110.

The radio node 110 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), agNB, a base transceiver station, a radio remote unit, an Access Point Base Station, a base station router, a transmission arrangement of a radio base station, a stand-alone access point or any other network unit capable of communicating with a wireless device within the service area served by the radio node 110 depending e.g. on the first radio access technology and terminology used. The radio node 110 may be referred to as a serving radio network node and communicates with a wireless device 120 with Downlink (DL) transmissions to the wireless device 120 and Uplink (UL) transmissions from the wireless device 120.

In the wireless communication network 100, one or more UEs operate, such as e.g. the wireless device 120. In some embodiments herein the wireless device 120 may be a radio node and is in these embodiments referred to as the radio node 120. The wireless device 120 may also be referred to as a device, an IoT device, a mobile station, a non-access point (non-AP) STA, a STA, a user equipment, a terminal and/or a wireless terminal, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The wireless communications network 100 may comprise a repeater 130. The repeater may repeat signals, such as e.g. reference signals, for attempting to obstruct, disrupt, block and/or prevent a signal for positioning estimation or synchronization.

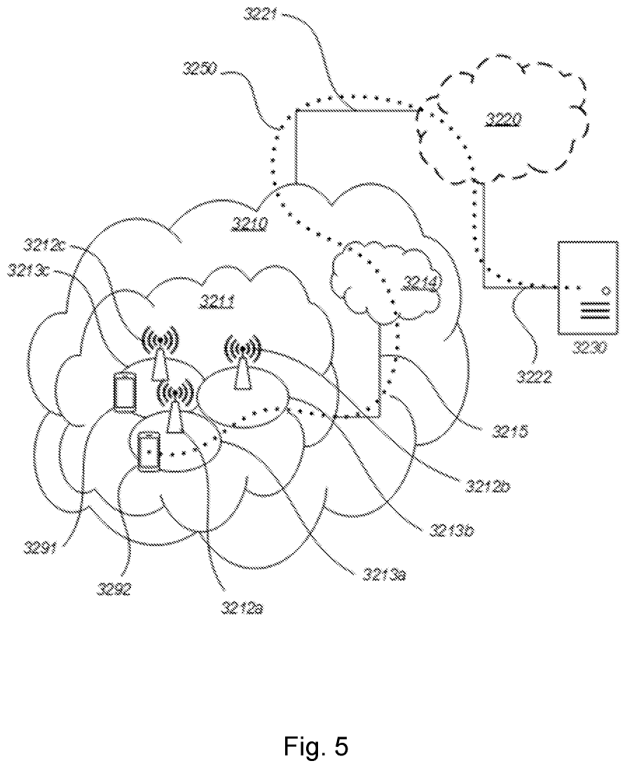

Methods herein may be performed by the radio node 110, 120. As an alternative, a Distributed Node (DN) and functionality, e.g. comprised in a cloud 135 as shown in FIG. 5, may be used for performing or partly performing the methods herein.

Embodiments herein e.g. provide a method for determining the presence of a repeater repeating signals, e.g. in order to detect a meaconing attack by analyzing multipath patterns.

Advantages of embodiments herein e.g. comprise that the reliability of the wireless communications network 100 for navigation services and clock synchronization services is improved. Further, a more efficient determination of ongoing attacks is provided.

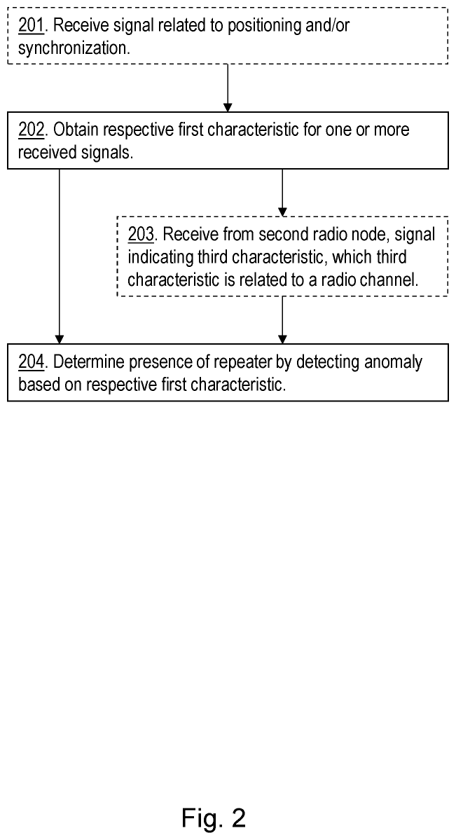

FIG. 2 shows example embodiments of a method performed by the radio node 110, 120 for determining the presence of a repeater 130 repeating a signal related to positioning or synchronization in a wireless communications network 100. A signal related to positioning may e.g. be a satellite positioning signal, such as a GNSS signal or reference signal transmitted by one or multiple radio base stations. The signal may be used for triangulation purposes by the wireless device. The signal may include information about location of the radio base stations and information about a reference time. A signal related to synchronization may e.g. be reference signal transmitted by a radio base station, allowing the UE to align its reception and transmission timing with the radio base station. Furthermore, the signal related to synchronization may include information about a reference time. In some embodiments the radio node 110, 120 is represented by any one out of: a wireless device 120, and the network node 110. The radio node 110, 120 may be represented by the wireless device 120 when the another radio node 110, 120 is represented by the network node 110. The radio node 110, 120 may be represented by the network node 110 when the another radio node 110, 120 is represented by the wireless device 120. The repeater 130 repeating signals may e.g. repeat the signals for performing a meaconing attack or interfere, such as obstruct, disrupt, block and/or prevent, positioning estimation of the radio node 110, 120 or synchronization between the radio node 110, 120 and the wireless communications network 100. A meaconing attack when used herein may mean the malicious attempt to obstruct, disrupt, block and/or prevent a signal for positioning estimation or synchronization, by repeating the signal in node.

Action 201. In some embodiments the radio node 110, 120 receives a signal related to positioning or synchronization. The signal may be related to both positioning and synchronization. A signal related to positioning may e.g. be a satellite positioning signal, such as a GNSS signal, or a signal received from the another radio node 110, 120. The signal received from the another radio node 110, 120 may be any radio signal used by the radio node 110, 120 to estimate its position, such as e.g. a positioning reference signal, or system information block (SIB). A signal related to synchronization may e.g. be a reference signal, or a SIB.

Action 202. The radio node 110, 120 obtains a respective first characteristic for one or more received signals. The first characteristic is any one or more out of: An autocorrelation of a received signal, and a value representative of a radio channel related to a received signal, and The one or more received signals may be related to positioning or synchronization. A characteristic when used herein may mean e.g. a calculated and/or estimated property or value. Obtaining when used herein may mean e.g. calculating, determining and/or estimating. In some embodiments the radio node 110, 120 obtains the respective first characteristic of the one or more received signals by any one out of: Calculating the respective autocorrelation of one or more received signals, or estimating, based on the one or more received signals, a respective value representative of a radio channel related to the one or more received signals. The estimated value may e.g. be a hash value such as a value representing the signal that is e.g. derived from the signal or its autocorrelation. The first radio node 110, 120 may estimate the value based on e.g. Reference Signal Received Power (RSRP), Channel State Information (CSI) measurements and/or Timing Advance (TA) propagation delay estimates, the autocorrelation of the signal or other properties of the signal. The one or more signals may be received from a second radio node 110, 120 or from a GNSS node, e.g. a satellite. The radio channel may be a radio channel between the first radio node 110, 120 and the second radio nodes 110, 120.

Action 203. In some embodiments the radio node 110, 120 receives a signal indicating a third characteristic. The signal is received from the another radio node 110, 120. The third characteristic is related to a radio channel. The signal indicating the third characteristic may be an encrypted signal. In some embodiments the third characteristic is represented by a value estimated by the second radio 110, 120. The value being representative of the radio channel between the another radio node 110, 120 and radio node 110, 120. The estimated value may e.g. be a hash value such as a value representing the signal that is e.g. derived from the signal or its autocorrelation. The radio node 110, 120 may estimate the value based on e.g. Reference Signal Received Power (RSRP), Channel State Information (CSI) measurements and/or Timing Advance (TA) propagation delay estimates, the autocorrelation of the signal or other properties of the signal.

Action 204. The radio node 110, 120 determines the presence of the repeater 130 by detecting an anomaly based on the respective first characteristic. In some embodiments the radio node 110, 120 determines the presence of the repeater 130 by further comparing the first characteristic of at least two of the one or more received signals. The at least two received signals are received at different times. The anomaly is represented by a second characteristic appearing with the same delay in the respective first characteristic of the at least two received signals. In other words, the first radio network node 110, 120 compares the respective first characteristic, such as e.g. the autocorrelation, of the at least two received signals. When detecting that the respective first characteristics comprises a second characteristic that appears, such as is detectable, with the same delay in the respective first characteristic, the radio node 110, 120 determines that the repeater 130 repeating the received signals is present in the wireless communications network. In some embodiments wherein the second characteristic comprises a multipath component of the at least two received signals. The multipath component may be represented by a spike in the respective first characteristic, such as e.g. the calculated autocorrelation. In some embodiments the radio node 110, 120 determines the presence of the repeater 130 by further comparing the respective first characteristic with the third characteristic. The anomaly is represented by the respective first characteristic being different from the third characteristic. In other words, the radio node 110, 120 compares the obtained first characteristic, such as the value, estimated by the radio node 110, 120, being representative of the radio channel between the radio node 110, 120 and the another radio node 110, 120, with the obtained third characteristic, such as the value, estimated by the another radio node 110, 120, being representative of the radio channel between the radio node 110, 120 and the another radio node 110, 120. When the first characteristic and the third characteristic do not match, e.g. being different from each other, the radio node 110, 120 determines that a repeater 130 repeating the received signals is present in the wireless communications network. Different when used here mean that the first and third characteristic is not identical. Or it may mean that they differ to certain percentage that is above or equal to threshold.

The above embodiments will now be further explained and exemplified below. The embodiments below may be combined with any suitable embodiment above.

When a device, such as e.g. the radio node 110, 120, of which the position is to be calculated, is subject to a meaconing attack the signal will travel either from the meaconing equipment, such as e.g. the repeater 130, to the device, in case of downlink 3GPP positioning or GNSS positioning, or alternatively from the device to the meaconing equipment, in case of uplink 3GPP positioning. In both these cases all the signals will be subject to the same multipath propagation environment between the meaconing equipment and the device. A comparison of the multipath in the different signals can thus be used as a meaconing detector, such as the radio node 110, 120 determining the presence of the repeater 130 repeating signals related to positioning or synchronization.

Actions S301-S302 are related to an example of embodiments herein for determining the presence of a repeater 130 repeating signals related to positioning or synchronization.

S301. The device, such as e.g. the radio node 110, 120, may receive signals, e.g. related to positioning or synchronization. The device calculates, such as obtains, the autocorrelation, such as the first characteristic, of the received signals. The signals may have been received at different times. The first characteristic may be related to parameters associated with multipath indications.

This action is related to Actions 201 and 202 described above.

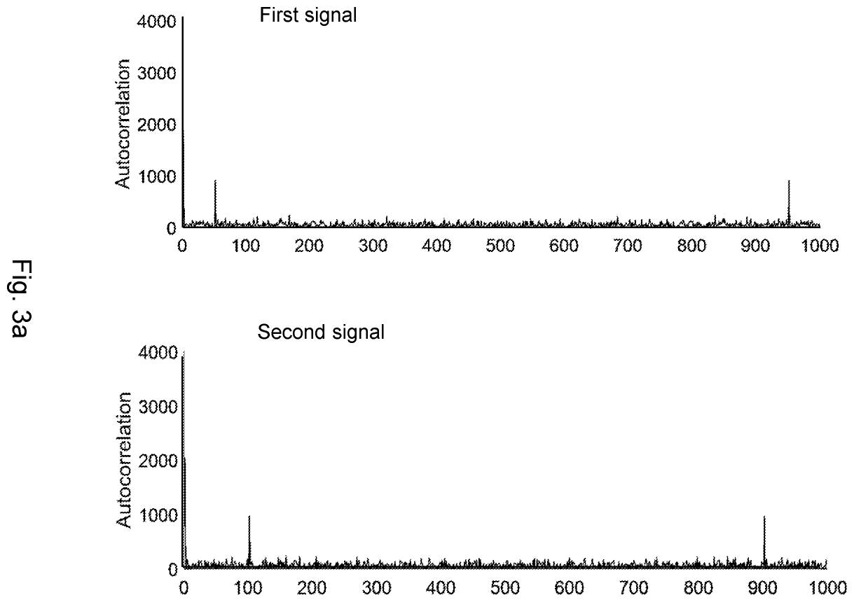

S302. Based on the autocorrelation, such as the respective first characteristic, the device detects, such as determines, that a meaconing attack is ongoing, such as the presence of the repeater 130. The device may compare the different autocorrelation curves, such as the respective first characteristic, of the received signals. If there are strong peaks with the same delay, such as e.g. the second characteristic, this is an indication that a meaconing attack is ongoing, such as detecting the anomaly. FIGS. 3a-b show an example of two received signals, referred to as a first signal and a second signal, that each are subject to different multipath components. FIGS. 3a-b show the obtained first characteristic, such as the autocorrelation, of the first and second signals. FIG. 3a shows the first and second signals when no repeater 130 repeating the signals is present, such as e.g. no meaconing attack is ongoing. FIG. 3b shows that the first and second signals have a common multipath component with a delay of 200 samples, which is not present in FIG. 3a. This indicates the presence of the repeater 130 repeating the signals is present, such as e.g. that a meaconing attack is ongoing, where common multipath component with same delay is the detected anomaly, e.g. the second characteristic.

This action is related to Action 204 described above.

An alternative is to compare the multipath environment as seen at a transmitter and a receiver. Actions S310-S312 are related to an example of embodiments herein for determining the presence of the repeater 130 repeating signals related to positioning or synchronization.

S310. A transmitter, such as e.g. the another radio node 110, 120, may regularly send a value and/or hash, such as e.g. the third characteristic, to a receiver, such as e.g. the radio node 110, 120. The value and/or hash may be encrypted. The value and/or hash may be representative of the radio channel between the receiver and the transmitter, such as e.g. a range of an expected received signal strength, a propagation delay, channel state/quality, expected multipath characteristics. The transmitter may estimate what is typical and/or to be expected based on of previous received feedback from receiver, such as e.g. Reference Signal Received Power (RSRP), Channel State Information (CSI) and/or Timing Advance (TA) propagation delay estimate and/or multipath characteristics. The function to derive the value and/or hash from these inputs may be performed by any suitable method and may be standardized.

This action is related to Action 203 described above.

S311. The receiver estimates a value and/or hash, such as e.g. the first characteristic. The estimation may be performed in same way as by the transmitter, as described above, but based on its own observations of e.g. RSRP, CSI measurements and/or TA propagation delay estimates and/or multipath characteristics, such as e.g. based on one or more received signals.

This action is related to Actions 201 and 202 described above.

S312. The receiver regularly compares whether its own estimated value and/or hash, such as e.g. the first characteristic, matches the encrypted value and/or hash received from the transmitter, such as e.g. the third characteristic. When they do not match, it is an indication that a meaconing attack is ongoing. In other words, the receiver determines the presence of the repeater 130 repeating the signal when the received value and/or hash does not match its own estimated value and/or hash.

This action is related to Action 204 described above.

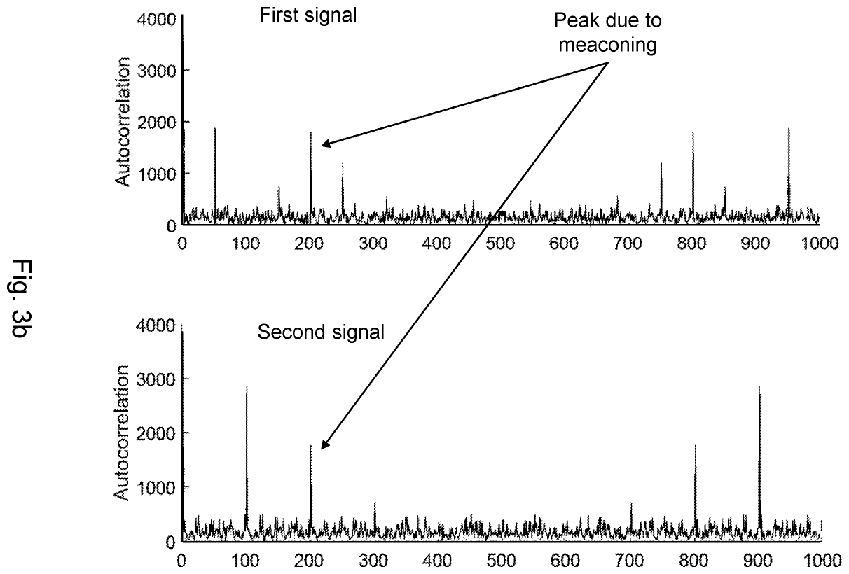

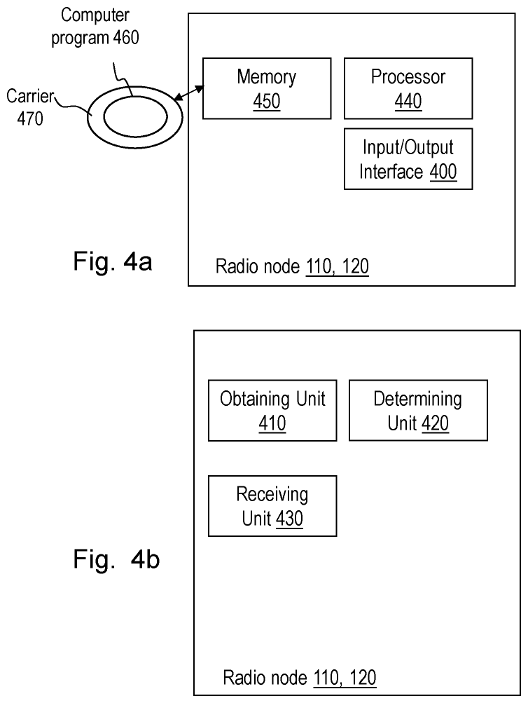

To perform the method actions above, the radio node 110, 120 is configured to determine the presence of the repeater 130 repeating a signal related to positioning or synchronization in a wireless communications network 100. The radio node 110, 120 may comprise an arrangement depicted in FIGS. 4a and 4b.

The radio node 110, 120 may comprise an input and output interface 400 configured to communicate with radio nodes such as the another radio node 110, 120 and other network nodes in the wireless communications network 100. The input and output interface 400 may comprise a wireless receiver (not shown) and a wireless transmitter (not shown).

The radio node 110, 120 may be adapted to be represented by any one out of: a wireless device 120, and a network node 110 such as a base station.

The radio node 110, 120 is further configured to, e.g. by means of an obtaining unit 410 in the radio node 110, 120, obtain a respective first characteristic for one or more received signals. The first characteristic is adapted to be any one or more out of: An autocorrelation of a received signal, and a value representative of the radio channel related to a received signal.

The radio node 110, 120 may further be configured to, e.g. by means of the obtaining unit 410 in the radio node 110, 120, obtain the respective first characteristic of the one or more received signals by further being configured to any one out of: Calculate the respective autocorrelation of one or more received signals, and estimate, based on the one or more received signals, a respective value adapted to be representative of a radio channel related to the one or more received signals.

The radio node 110, 120 is further configured to, e.g. by means of a determining unit 420 in the radio node 110, 120, determine the presence of the repeater 130 by detecting an anomaly based on the respective first characteristic.

The radio node 110, 120 may further be configured to, e.g. by means of the determining unit 420 in the radio node 110, 120, determine the presence of the repeater 130 by further being configured to compare the first characteristic of at least two of the one or more received signals. The at least two received signals are adapted to be received at different times. The anomaly is adapted to be represented by a second characteristic appearing with the same delay in the respective first characteristic of the at least two received signals.

The radio node 110, 120 may further be configured to, e.g. by means of the determining unit 420 in the radio node 110, 120, determine the presence of the repeater 130 by further being configured to compare the respective first characteristic of the one or more received signals with the third characteristic. The anomaly is adapted to be represented by the first characteristic being different from the third characteristic.

The radio node 110, 120 may further be configured to, e.g. by means of a receiving unit 430 in the radio node 110, 120, receive from the another radio node 110, 120, a signal adapted to indicate a third characteristic. The third characteristic is adapted to be related to a radio channel.

The third characteristic may be adapted to be represented by a value estimated by the second radio 110, 120. The value is adapted to be representative of the radio channel between the another radio node 110, 120 and radio node 110, 120.

The radio node 110, 120 may further be configured to, e.g. by means of the receiving unit 430 in the radio node 110, 120, receive a signal adapted to be related to positioning or synchronization.

The embodiments herein may be implemented through a respective processor or one or more processors, such as the processor 440 of a processing circuitry in the radio node 110, 120 depicted in FIG. 4a, together with respective computer program code for performing the functions and actions of the embodiments herein. The program code mentioned above may also be provided as a computer program product, for instance in the form of a data carrier carrying computer program code for performing the embodiments herein when being loaded into the radio node 110, 120. One such carrier may be in the form of a CD ROM disc. It is however feasible with other data carriers such as a memory stick. The computer program code may furthermore be provided as pure program code on a server and downloaded to the radio node 110, 120.

The network node 110 may further comprise a memory 450 comprising one or more memory units. The memory 450 comprises instructions executable by the processor in the radio node 110, 120. The memory 450 is arranged to be used to store e.g. signals, characteristics, values, anomalies and applications to perform the methods herein when being executed in the radio node 110, 120.

In some embodiments, a computer program 460 comprises instructions, which when executed by the respective at least one processor 440, cause the at least one processor 440 of the radio node 110, 120 to perform the actions above.

In some embodiments, a respective carrier 470 comprises the respective computer program 460, wherein the carrier 470 is one of an electronic signal, an optical signal, an electromagnetic signal, a magnetic signal, an electric signal, a radio signal, a microwave signal, or a computer-readable storage medium.

Those skilled in the art will appreciate that the units in the radio node 110, 120 described above may refer to a combination of analog and digital circuits, and/or one or more processors configured with software and/or firmware, e.g. stored in the radio node 110, 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

With reference to FIG. 5, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the radio node 110, 120 and the another radio node 110, 120, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the radio node 110, 120 and the another radio node 110, 120 such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 5 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

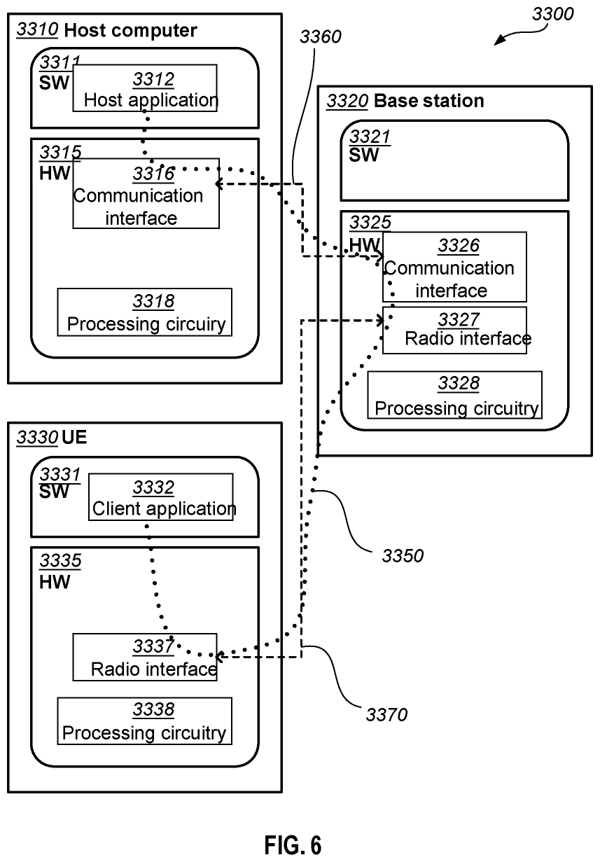

Example implementations, in accordance with an embodiment, of the UE, base station and host computer discussed in the preceding paragraphs will now be described with reference to FIG. 6. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 6) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 6 may be identical to the host computer 3230, one of the base stations 3212a, 3212b, 3212c and one of the UEs 3291, 3292 of FIG. 5, respectively. This is to say, the inner workings of these entities may be as shown in FIG. 6 and independently, the surrounding network topology may be that of FIG. 5.

In FIG. 6, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

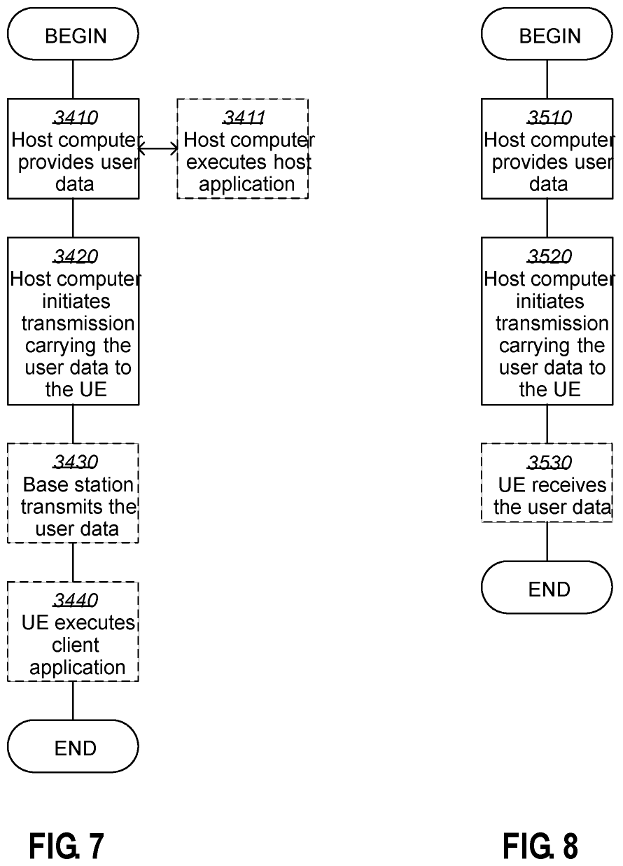

FIG. 7 is a flowchart illustrating a method implemented in a communication system, in accordance with one embodiment. The communication system includes a host computer, a base station such as the network node 112, and a UE such as the UE 120, which may be those described with reference to FIG. 5 and FIG. 6. For simplicity of the present disclosure, only drawing references to FIG. 7 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 8 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

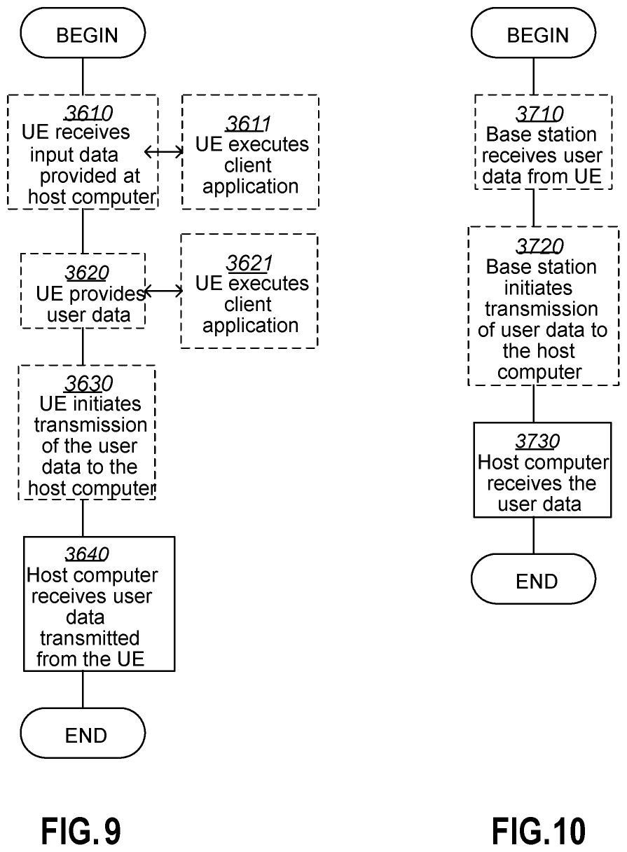

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 9 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 10 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a radio node for determining the presence of a repeater repeating a signal related to positioning or synchronization in a wireless communications network, the method comprising:
obtaining a respective first characteristic for one or more received signals, which first characteristic is any one or more out of:
an autocorrelation of a received signal; and
a value representative of a radio channel related to a received signal; and
determining the presence of the repeater by detecting an anomaly based on the respective first characteristic.

2. The method according to claim 1, wherein determining the presence of the repeater further comprises comparing the first characteristic of at least two of the one or more received signals, which at least two received signals are received at different times, and wherein the anomaly is represented by a second characteristic appearing with the same delay in the respective first characteristic of the at least two received signals.

3. The method according to claim 2, wherein the second characteristic comprises a multipath component of the at least two received signals.

4. The method according to claim 1, further comprising:
receiving from another radio node, a signal indicating a third characteristic, which third characteristic is related to a radio channel; and
wherein determining the presence of the repeater further comprises comparing the respective first characteristic with the third characteristic, and wherein the anomaly is represented by the first characteristic being different from the third characteristic.

5. The method according to claim 4, wherein the third characteristic is represented by a value estimated by the second radio, the value being representative of the radio channel between the another radio node and radio node.

6. The method according to claim 1, wherein obtaining the respective first characteristic of the one or more received signals comprises any one out of:
calculating the respective autocorrelation of the one or more received signals; and
estimating, based on the one or more received signals, a respective value representative of a radio channel related to the one or more received signals.

7. The method according to claim 1, further comprising:
receiving a signal related to positioning or synchronization.

8. The method according to claim 1, wherein the radio node is represented by any one out of:
a wireless device; and
a network node.

9. A computer storage medium storing a computer program comprising instructions, which when executed by a processor, causes the processor to:
obtain a respective first characteristic for one or more received signals, which first characteristic is any one or more out of:
an autocorrelation of a received signal; and
a value representative of a radio channel related to a received signal; and
determine the presence of a repeater repeating a signal related to positioning or synchronization in a wireless communications network by detecting an anomaly based on the respective first characteristic.

10. (canceled)

11. A radio node configured to determine the presence of a repeater repeating a signal related to positioning or synchronization in a wireless communications network, the radio node further being configured to:
obtain a respective first characteristic for one or more received signals, which first characteristic is adapted to be any one or more out of:
an autocorrelation of a received signal, and
a value representative of a radio channel related to a received signal, and
determine the presence of the repeater by detecting an anomaly based on the respective first characteristic.

12. The radio node according to claim 11, wherein the radio node is configured to determine the presence of the repeater by further being configured to compare the first characteristic of at least two of the one or more received signals, which at least two received signals are adapted to be received at different times, and wherein the anomaly is adapted to be represented by a second characteristic appearing with the same delay in the respective first characteristic of the at least two received signals.

13. The radio node according to claim 12, wherein the second characteristic is adapted to comprise a multipath component of the at least two received signals.

14. The radio node according to claim 11, further being configured to:
receive from another radio node, a signal adapted to indicate a third characteristic, which third characteristic is adapted to be related to a radio channel; and
wherein the radio node is configured to determine the presence of the repeater by further being configured to compare the respective first characteristic of the one or more received signals with the third characteristic, and wherein the anomaly is adapted to be represented by the first characteristic being different from the third characteristic.

15. The radio node according to claim 14, wherein the third characteristic is adapted to be represented by a value estimated by the second radio, the value adapted to be representative of the radio channel between the another radio node and radio node.

16. The radio node according to claim 15, wherein the radio node is configured to obtain the respective first characteristic of the one or more received signals by further being configured to any one out of:
calculate the respective autocorrelation of one or more received signals, and
estimate, based on the one or more received signals, a respective value adapted to be representative of a radio channel related to the one or more received signals.

17. The radio node according to claim 11, further being configured to:
receive a signal adapted to be related to positioning or synchronization.

18. The radio node according to claim 11, wherein the radio node is adapted to be represented by any one out of:
a wireless device; and
a network node.

19. The method according to claim 2, wherein obtaining the respective first characteristic of the one or more received signals comprises any one out of:
calculating the respective autocorrelation of the one or more received signals; and
estimating, based on the one or more received signals, a respective value representative of a radio channel related to the one or more received signals.

20. The method according to claim 2, further comprising:
receiving a signal related to positioning or synchronization.

21. The method according to claim 2, wherein the radio node is represented by any one out of:
a wireless device; and
a network node.
